(19) United States
(12) Patent Application Publication
(10) Pub. No.: US 2004/0083279 A1
(43) Pub. Date: Apr. 29, 2004

(54) Method for backup wireless area network

(76) Inventor: Robert Lin, Taipei (TW)

Correspondence Address: Robert Lin, P.O. Box 4-67, Hsin-Chuang, Taipei Hsien, 242, TW

(21) Appl. No.: 10/278,926

(22) Filed: Oct. 24, 2002

(51) Int. Cl. G06F 15/177

(52) U.S. Cl. 709/222

(57) ABSTRACT

A method for backup a wireless area network is disclosed. The wireless area network has a main connecting device and a backup connection device. The settings of the main connecting device and parameters inputted by the system manager and stored in the main connecting device are backup in the backup connection device. The backup settings and parameters of the backup connection device is adjustable to be the same as or different from those the main connecting device. The method comprises the steps of a system diagnostic and testing procedure, a system parameter modification procedure, a system sleep and awake procedure, and a system alert procedure. Thereby, the settings and parameters of a wireless area network can be backup for avoiding the wireless area network to shutdown. Thereby, the wireless area network is used safely.

### FIELD OF THE INVENTION

The present invention relates to network backup methods, and particularly to a method for backup a wireless area network, wherein the system has a main connecting device and a backup connection device, the backup connection device serves to backup the settings and parameters of the main connecting device so as to replace the main connecting device when the main connecting device has faults.

### BACKGROUND OF THE INVENTION

Current wireless area network mainly serves for connecting the devices, such as wireless exchanges, wireless routers, etc. for avoiding the interference of signals. For the sake of easy installation, a single one system is used so that the network system manager can set and manage the system. Once the system has faults, such as disconnection, power-off, system shutdown, etc., most of the users must be off-lined so as to interrupt the works. Moreover, it is very possible that the data being processed would be lost. This is a very worse condition, especially when the system is a large scale client service system of for example a transaction server so that a large lose occurs.

To recover the system, the system managers must take a great amount of working times to restore the system. However, this is because the data about the network hardware has no backup copy. Namely, the settings and parameters of the network has no backup copy. Thereby, there is an eager demand for a novel system which can backup the settings and parameters about the hardware of a network system so as to resolve the problem encountered in the prior art design.

### SUMMARY OF THE INVENTION

Accordingly, the primary object of the present invention is to provide a method for backup a wireless area network. The wireless area network has a main connecting device and a backup connection device. The settings of the main connecting device and parameters inputted by the system manager and stored in the main connecting device is backup in the backup connection device. The backup settings and parameters of the backup connection device is adjustable to be the same as or different from those the main connecting device. The method comprises the following steps of a system diagnostic and testing procedure, a system parameter modification procedure, a system sleep and awake procedure, and a system alert procedure.

The various objects and advantages of the present invention will be more readily understood from the following detailed description when read in conjunction with the appended drawing.

### BRIEF DESCRIPTION OF THE DRAWINGS

FIG. 1 is a schematic view showing the system structure of the present invention.

FIG. 2 is a functional block diagram of the present invention.

FIG. 3 is another functional block diagram of the present invention.

FIG. 3-1 is a schematic view showing the operation of the present invention.

FIG. 3-2 is another schematic view showing the operation of the present invention.

FIG. 4 is a schematic view showing the operation process of the present invention.

FIG. 4-1 shows a flow diagram about the system diagnostic and testing procedure of the present invention.

FIG. 4-2 shows a flow diagram about the system parameter modification procedure of the present invention.

FIG. 4-3 is a flow diagram about the system sleep and awake procedure of the present invention.

FIG. 4-4 is a flow diagram about the system alert procedure of the present invention.

### DETAILED DESCRIPTION OF THE PREFERRED EMBODIMENTS

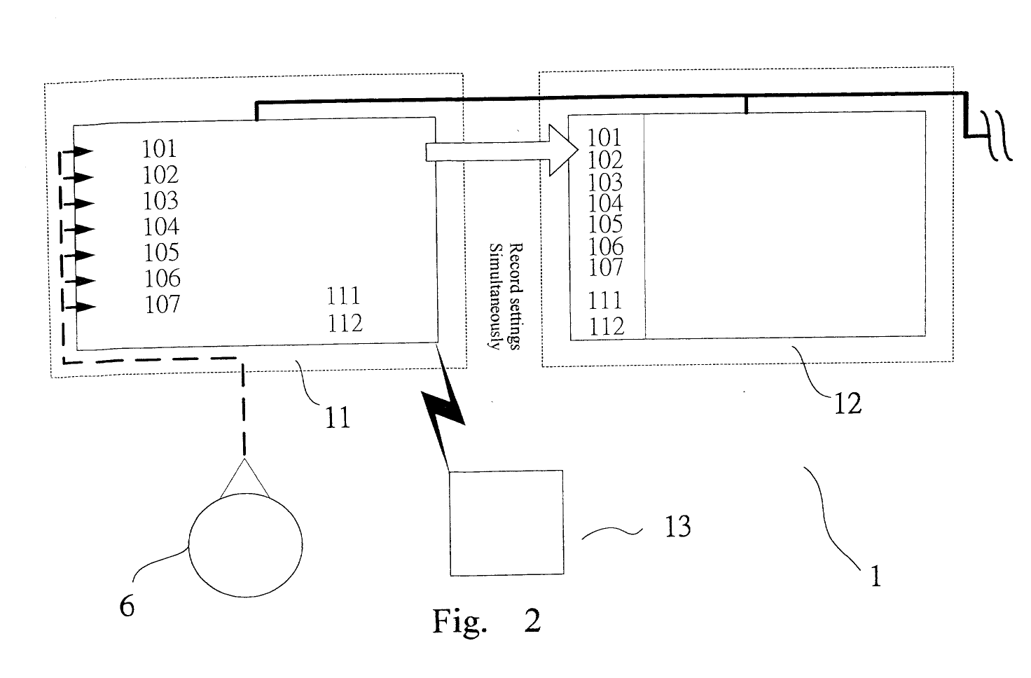

Referring to the drawings, the method for backup a wireless area network of the present invention is illustrated. By the present invention, the system manager can install, control and manage a wireless area network 1. The wireless area network 1 includes a main connecting device 11, for example, a wireless exchange and a backup connection device 12 matching to the wireless area network 1, such as another wireless exchange. Thereby, a computer having for example, a wireless area network card, can be connected to the wireless area network 1 through a platform 13. The function of the present invention is to control the backup connection device 12 so as to backup the settings and parameters of the main connecting device 11 in the wireless area network 1, such as the sector 101, domain name 102, host name 103, IP address 104, subnet 105, channel 106, wireless domain 107, user data 111, and connection data 112, referring to FIG. 2.

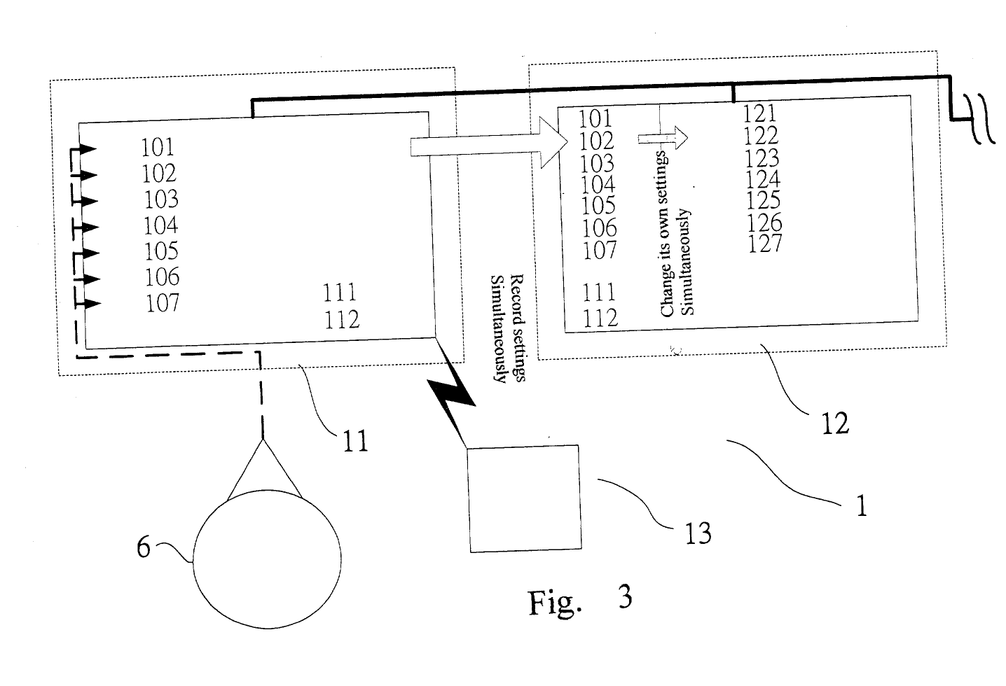

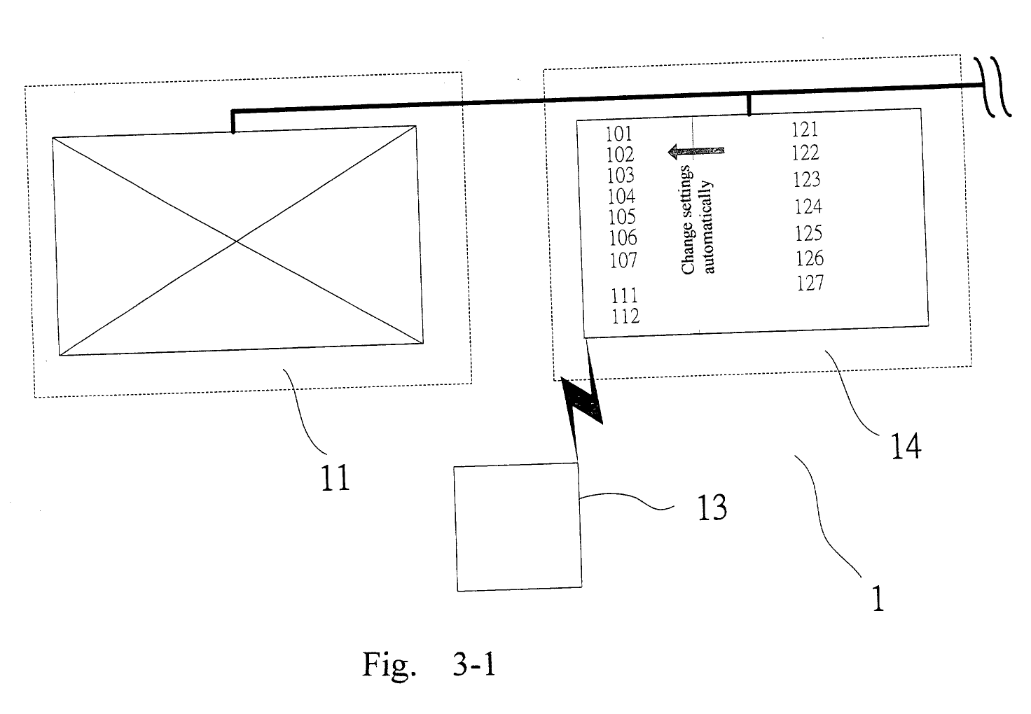

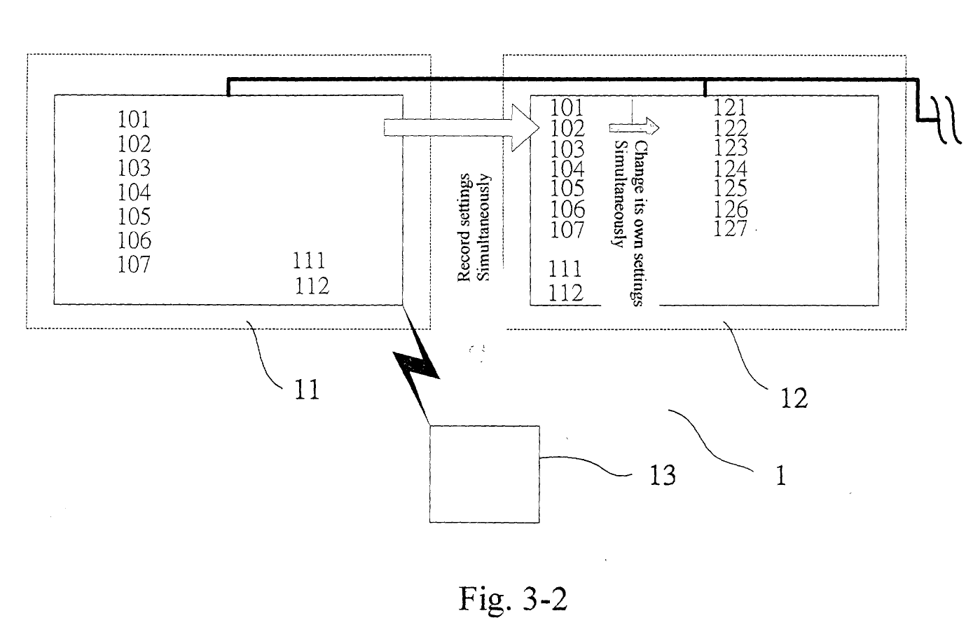

Another function of the present invention is that the backup connection device 12 can change the its own parameters. The backup connection device 12 changes the parameters with referring to the sector 101, domain name 102, host name 103, IP address 104, subnet 105, channel 106, wireless domain 107, user data 111, and connection data 112. In general, the parameters are adjusted to be different from above parameters, such as the sector 121, domain name 122, host name 123, IP address 124, subnet 125, channel 126, wireless domain 127, as shown in the FIG. 3 so as to avoid the signal conflict or inference in the same wireless area network 1.

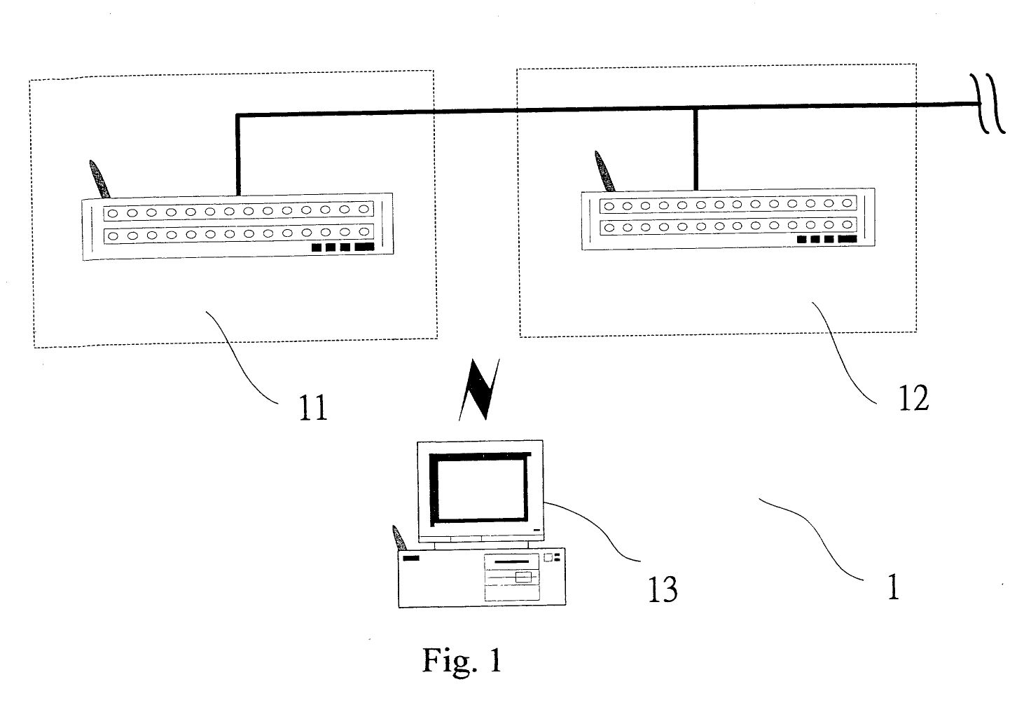

When the main connecting device 11 has abnormality and thus can not work continuously, the backup connection device 12 will reset its parameters to be the same as the main connecting device 11 for replacing the damaged main connecting device 11 so to be as a temporary main connecting device 14. Thereby, the connection in the wireless area network 1 is continued completely (referring to FIG. 3-1). When the damaged main connecting device 11 is repaired, the temporary main connecting device 14 is changed to the main connecting device 11. Then the parameters are changed again to be restored to the original backup connection device 12 (referring to FIG. 3-2).

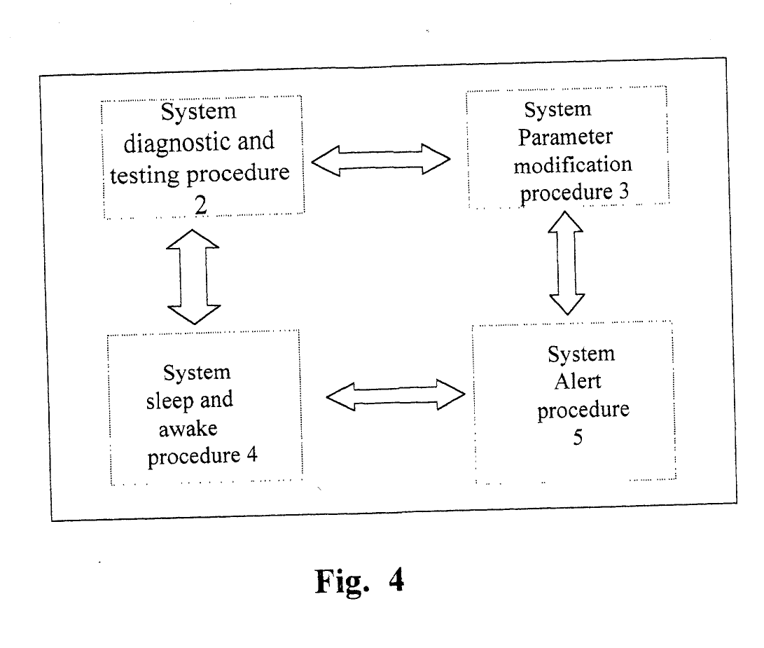

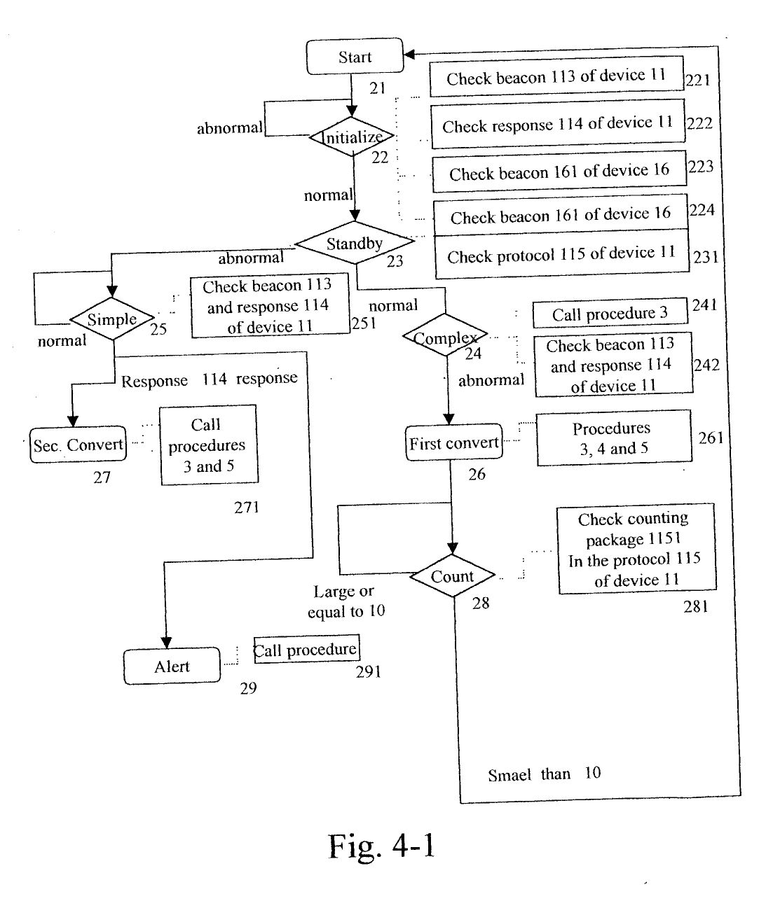

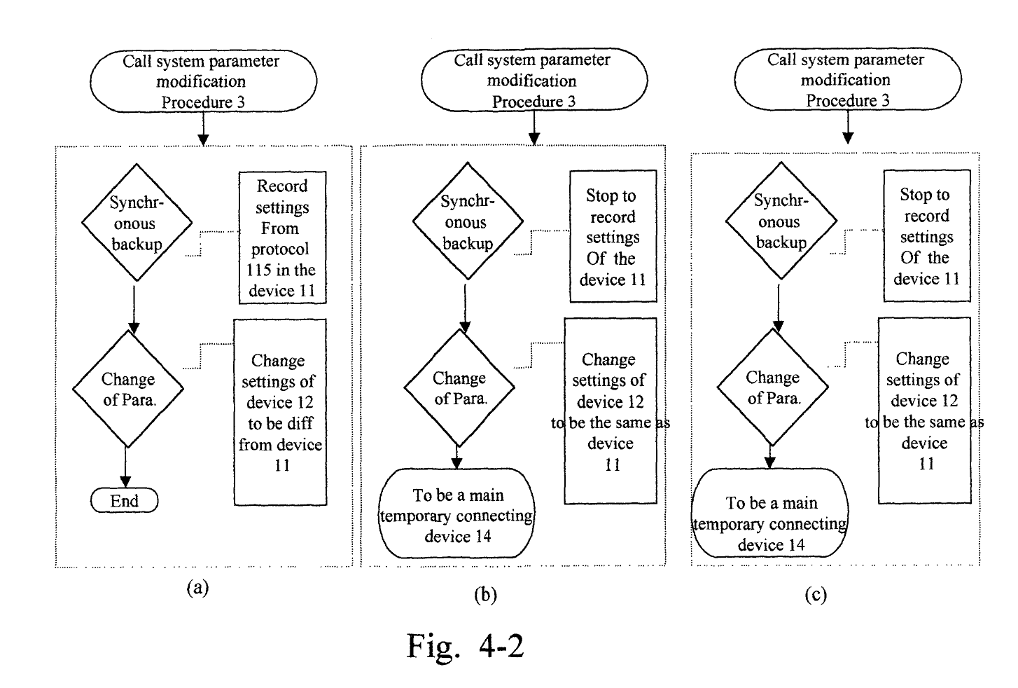

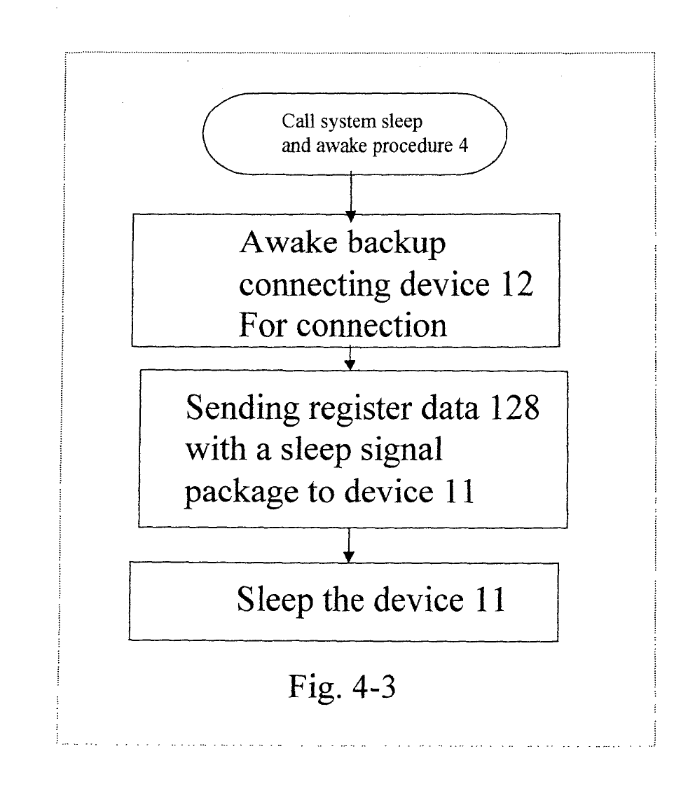

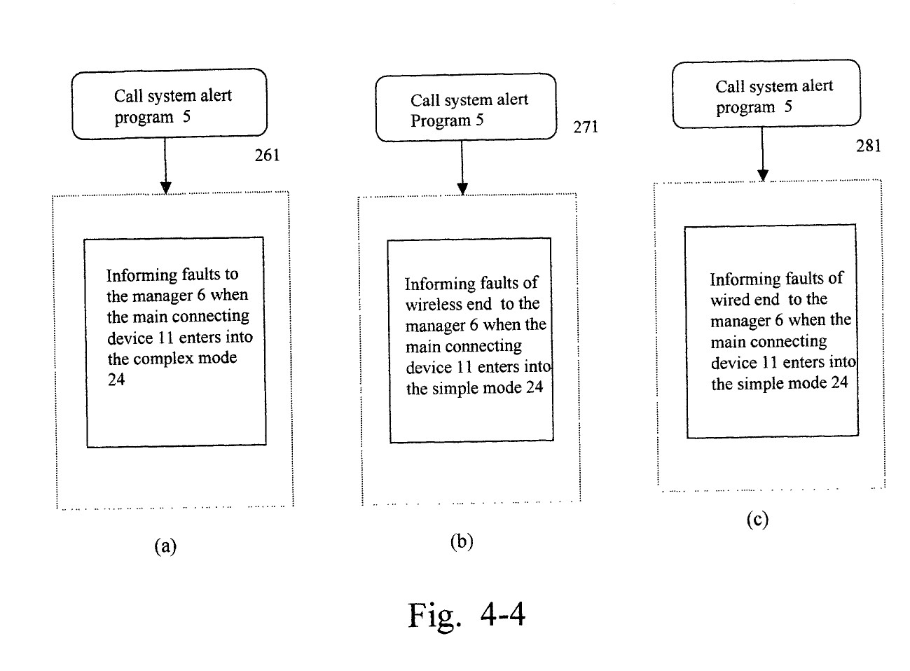

In the method for backup a wireless area network of the present invention, a plurality of procedures are included. These procedures are coupled to finish the procedures, such as; a system diagnostic and testing procedure 2, a system parameter modification procedure 3, a system sleep and awake procedure 4 and a system alert procedure 5, (referring to FIG. 4).

In the system diagnostic and testing procedure 2, the backup connection device 12 periodically tests the main connecting device 11 and the operation of the system itself. If it is discovered that the main connecting device 11 has faults, the backup connection device 12 will used to replace the main connecting device 11 for performing all the connection works and informing the system manager about this condition.

If it is known that the backup connection device 12 has faults, the condition is informed to the system manager 6 and a record file is generated for being referenced by the system manager 6.

The system diagnostic and testing procedure 2 (referring to FIG. 4-1) is initiated from step 21. Then in the system initialization process of step 22, a program 221 is performed to check whether the beacon signal 113 from the main connecting device 11 can be received correctly. If it is correct, it represents that a wireless end of the main connecting device II is correct. Then the program 222 is continued. If the beacon signal cannot be received correctly, then the program 221 is over and the program 223 are run.

In program 222, it is to check whether the response 114 from the main connecting device 11 is correct. If it can be received correctly, then it represents that the wired end of the main connecting device 11 is correct. Then the system initialization of the backup connection device 12 is complete. Then the process enters into a backup procedure 23. If in program 222, the ping response 114 is incorrect, then the program 222 is over and the process enters into the program 224.

In program 223, it is to check whether another reference connection device 16 at the same area has emitted a beacon signal 161. If the receiving result is correct, it represents that the wireless end of the main connecting device 11 is incorrect or no main connecting device exists. Then the program 223 is over and the process returns to program 221 to check repeatedly. If no beacon signal 161 is received, it represents that the backup connection device 12 is incorrect, the program 223 is over and a record is made for being used afterwards.

In program 224, the system checks whether the response 151 from another reference device 15 at the same wireless area network 1 is correct. If yes, then it represents that the practical wires of the wireless area network 1, the backup connection device 12 and the reference device 15 are correct, and then the program 224 is over, and a record is generated for being used afterwards. If the response 151 from the reference device 15 is incorrect, then the program 224 determines that the main connecting device 11 has faults. The program 224 is over and a record is generated for being used afterwards.

When the system enters into the backup process 23. In step 23, the program is run to check whether the main connecting device 11 have sent an inter access point protocol 115. If the inter access point protocol 115 exists, it represents that the inter access point protocol 115 has a known type (made by the same manufacturer). After completing the program 231, the process enters into a complex mode step 24. If it is determined that no inter access point protocol 115 exists (the main connecting device 11 is made by different manufacturer), then after completing the program 231, the process enters into a simple mode step 25.

In a program 241 of the complex mode step 24, the process calls the system parameter modification procedure 3. In that, the main connecting device 11 changes its parameters so that these parameters are different from those in the main connecting device 11. Then by the program 242, the beacon signal 113 and response 114 from the main connecting device 11 are checked continuously, if the result is correct, it represents that the main connecting device 11 is correct, the program 224 runs continuously. If any one of the beacon signal 113 and response 114 has faults (bad quality, discontinuity, or weak signals), it represents that the main connecting device 11 has faults, the process determines that the main connecting device 11 has faults. After the program 242 is over, the process enters into a first converting step 26. Initiating the first converting step 26, a program 261 calls the system parameter modification procedure 3, system sleep and awake procedure 4, and system alert procedure 5 so that the backup connection device 12 changes its parameters with reference to the settings and parameters which are previous backups of the main connecting device 11 so that the parameters are identical to the main connecting device 11. Then the main connecting device 11 is replaced by the system as a temporary main connecting device 14. Then the fault main connecting device II sleeps. Then the fault is informed to the system manager 6.

After program 261 is over, the process enters into step 28 for counting. In this step 28, a program 281 checks whether the inter access point protocol 115 from the original main connecting device 11 is correct. If no inter access point protocol 115 exists, it represents that the main connecting device 11 is not on line. If the inter access point protocol 115 exists, it represents that main connecting device 11 is on line. The program 281 checks the counts of a counting package 1151 in the inter access point protocol 115. If the data of the counting package 1151 larger than or equal to 10, it represents that although the main connecting device 11 is on line, but the fault has not be removed. The program 281 performs the check process continuously. Once it finds that the counting in the counting package 1151 is smaller than 10 or is 0, it represents that the faults of the main connecting device 11 have been removed and the main connecting device 11 has reset. Then the program 281 is over. The system returns to initialization process 21 to restart. Then the temporary main connecting device 14 is returned to be as a backup connection device 12 for being used next time.

In the simple mode step 25, the program 251 is executed. In that, the beacon signal 113 and response 114 from the main connecting device 11 is checked. If the two are correct, then it represents that the main connecting device 11 is correct, the program 251 is performed continuously. Once it is determined that the beacon signal 113 is incorrect, it represents that the wireless end of the main connecting device 11 has faults. The user join network can not be used continuously. Then, the program 251 is over and the process enters into the second converting step 27. If the response 114 is incorrect, it represents that the wired end of the main connecting device 11 has faults although the user can add a network and the resource of the network cannot be accessed normally. Then the program 251 is over and the process enters into an alert step 29.

In the second converting step 27, the program 271 executes the system parameter modification procedure 3 and the system alert procedure 5. In that, the backup connection device 12 converts its own settings and parameters so that the setting and parameters are completely corresponding to the settings and parameters of the fault main connecting device 11 so as to replace the fault main connecting device 11 to be as a temporary main connecting device 14 for being used by users. Since under this mode, the main connecting device 11 and the backup connection device 12 are not made by the same manufacturer, the system sleeps and awake procedure 4 can not cause the main connecting device 11 to enter into a sleep condition. Thereby, an alert signal is sent to the system manager 6 for further processing.

In the alert step 29, the program 29 directly calls the system alert procedure 5 for informing the system manager 6. Since in this condition, it is possible that the main connecting device 11 has no fault, while it is possible that the practical wires or other devices have faults so that the response 114 cannot be received correctly. Moreover, the main connecting device 11 and the backup connection device 12 are not made by the same manufacturer. The system sleep and awake procedure 4 cannot cause the main connecting device 11 to enter into the sleep condition. Therefore, at this state, the backup connection device 12 is not directly converted into a temporary main connecting device 14. Only an alert signal is sent to the system manager 6.

In the system parameter modification procedure 3, the backup connection device 12 backups the settings and parameters of the main connecting device 11 which are inputted by the system manager 6. Normally, these settings and parameters are different from the settings and parameters of the main connecting device 11 for avoiding the signal conflict and interference to be occurred in the wireless area network 1. Moreover, the system manager 6 is unnecessary to adjust all the devices one by one. One the main connecting device 11 has faults, the settings and parameters of the main connecting device 11 can be retrieved so that the backup connection device 12 becomes a temporary main connecting device 14 for replacing the main connecting device 11 completely.

When the faults of the main connecting device 11 have been removed and is on line again, the system parameter modification procedure 3 will re-backup the settings and parameters of the main connecting device 11 and the settings and parameters of the temporary main connecting device 14 are changed to be different from those of the main connecting device 11. After the main connecting device 11 completely replaces the temporary main connecting device 14, the temporary main connecting device 14 is restored to the backup connection device 12.

The system parameter modification procedure 3 is executed by the system diagnostic and testing procedure 2 to call the program 241 in the complex mode step 24. In the system parameter modification procedure 3, firstly, a synchronous backup step 31 is executed and the program 311 backups (records) the settings and parameters of the main connecting device 11. The settings are sent by the data packages of the inter access point protocol 115 by the main connecting device 11. After the backup connection device 12 receives the data, the parameter change step 32 is executed. A program 321 serves to change the settings itself so as to be deviated from those of the main connecting device 11 for avoiding occurrence of interference (referring to FIG. 4-2a).

In the system parameter modification procedure 3, when the system diagnostic and testing procedure 2 determines that the main connecting device 11 (having a known type) knows that the main connecting device 11 has faults and enters into the first converting step 26, the program 261 calls to execute the system parameter modification procedure 3 so as to enter into the backup step 31 and to execute the program 312 to stop to synchronously backup the settings of the main connecting device 11. Then the parameter change step 32 executes the program 322 so that the backup connection device 12 to change its won parameters by the data of the backup main connecting device 11 again. Further, the backup connection device 12 is converted into a temporary main connecting device 14 to perform the connection work (referring to FIG. 4-2B).

In the system parameter modification procedure 3, when the system diagnostic and testing procedure 2 determines that the main connecting device 11 (having an unknown form) has faults, the second converting step 27 causes the program 271 to call the synchronous backup step 31 of the system parameter modification procedure 3. Then the program 312 is performed to stop the synchronous backup of the settings of the main connecting device 11. Then, in parameter change step 32, the program 322 is executed so that the backup connection device 12 changes the corresponding settings and is converted into a temporary main connecting device 14 for performing the network connection work (referring to FIG. 4-2C).

In the system sleep and awake procedure 4, a main connecting device 11 having a known type can enter into a sleep condition. In that, the main connecting device 11 sends an authentication data 128 to the main connecting device 11 and a sleep signal package 1281 is contained in the authentication data. By an authentication process matching the wireless area network control (802.22b), when the main connecting device 11 (having a new type) receives the sleep package 1281, it enters into a sleep state for being repaired by the system manager 6.

In the system sleep and awake procedure 4, when the system diagnostic and testing procedure 2 determines that the main connecting device 11 (having a known type) has faults and enters into a first converting step 26, the program 261 calls the system sleep and awake procedure 4 to be performed so that the backup connection device 12 awakes to replace the main connecting device 11. An authentication data 128 with a sleep signal package 1281 is sent to the main connecting device 11. Thereby, when the fault main connecting device 11 receives the package, it enters into the sleep condition for being repaired (referring to FIG. 4-3).

In the system alert procedure 5, the backup connection device 12 has an ability of alerting. Thereby, the abnormality of the synchronous is reported to the system manager 6. In that a standard simple network management protocol sends an alert message. When the system diagnostic and testing procedure 2 finds that the main connecting device 11 (having a known type) cannot work correctly, the system diagnostic and testing procedure 2 executes the second converting step 26 to cause the program 261 to perform the system alert procedure 5. Therefore, the faults of the main connecting device 11 are informed to the system manager 6 (referring to FIG. 4-4a).

In the system alert procedure 5, when the system diagnostic and testing procedure 2 finds that the wireless end of the main connecting device 11 (having an unknown type) has faults, the program 271 of the second converting step 27 calls the system alert procedure 5 to be performed so that the faults of the wireless end of the main connecting device 11 are informed to the system manager 6 (referring to FIG. 4-4b).

In the system alert procedure 5, when the system diagnostic and testing procedure 2 finds that the wired end of the main connecting device 11 (having a unknown type) has faults, the step 29 causes the program 291 to perform the system alert procedure 5 so that the faults in the wired end of the main connecting device 11 is informed to the system manager 6 (referring to FIG. 4-4c).

By above procedures, a main connecting device 11 and another at least one backup connection device 12 can be installed to the wireless area network 1 at the same time. The two connection device 11, 12 can backup and switch by the functions of the present invention. The mechanism of the present invention causes a wireless area network 1 to be managed automatically. The connection will not be interrupted so that the user can use it comfortably. The system manager would manage the system easily and effectively.

In the present invention, the settings of the main connecting device include the user data and connection data connecting to the main connecting device.

The advantages of the present invention will be described in the following:

1. The settings and parameters of a network are backup, so that the system manager can not worry about the system cannot work.

2. The adjustment and switching of system are automatically and conveniently.

3. The system can detect the destroys itself so that the repairing work can be positioned easily.

4. The system sleep and awake function causes the management of the system can be executed easily.

5. The present invention can be used for devices of different manufacturers so that the user can select it freely.

6. The present invention has a perfect alert function so that the condition of the network can be handled.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for backing-up a wireless area network; said wireless area network having a main connecting device and a backup connection device; the settings of the main connecting device and parameters inputted by the system manager and stored in the main connecting device being backup in the backup connection device; the settings and parameters of the backup connection device being adjustable to be the same as or different from those the main connecting device; the method performing the following process:
performing a system diagnostic and testing procedure,
performing a system parameter modification procedure,
performing a system sleep and awake procedure, and
performing a system alert procedure.

2. The method for backing-up a wireless area network as claim in claim 1, wherein the system diagnostic and testing procedure comprising the steps of:
(a1) actuating the system;
(a2) initializing the system for checking beacon signals and responses from the main connecting device;
if the beacon signals and responses are correct, the system entering into a backup mode step;
if any one of the beacon signals and responses are incorrect, the process entering into the step (a1);
(a3) the backup mode being performed to check whether the main connecting device has an inter access point protocol;
if yes, the system entering into a complex mode step; if not, the system enters into a simple mode step;
(a4) the complex mode step being performed to call a parameter change procedure;
the settings of the main connecting device and the parameters inputted by the system manager being recorded;
the settings and parameters of the backup connection device being changed to be different from those of the main connecting device; checking the beacon signals and responses of the main connecting device being checked;
if the beacon signal and responses are correct, then step (a4) being repeated; and
if any one of the beacon signals and responses are incorrect, then a first converting step being performed;
(a5) performing a simple mode step to check the beacon signals and responses of the main connecting device;
if the beacon signals and responses are correct, the step (a5) is repeated;
if beacon signals are incorrect, a second converting step is performed; and
if the responses are incorrect, an alert step being performed;
(a6) executing the first converting step to call the system parameter modification procedure, the system sleep and awake procedure and system alert procedure to change the settings and parameters in backup connection device so as to be equal to those of the main connecting device; an authentication data with sleep signal being emitted to the main connecting device so that the main connecting device enters into a sleep condition;
emitting an alert signal to the system manager; and performing a counting check step;
(a7) performing a second converting step to call the system parameter modification procedure and system alert procedure to change the settings and parameters of the backup connection device to be identical to those in the main connecting device; and
emitting an alert signal to the system manager;
(a8) executing a counting check step to check a count package emitted by the inter access point protocol of the main connecting device;
if the count in the count package being larger than or equal to 10, then the counting check step being performed repeatedly; and
if the count being smaller than 10, the system returning to step (a1); and
(a9) performed an alert step to send an alert signal to the system manager.

3. The method for backing-up a wireless area network as claim in claim 2, wherein when the complex mode step calls the system parameter modification procedure; the system parameter modification procedure comprises the steps of:
(b1) performing a synchronous backup step to record the settings and parameters in the inter access point protocol of the main connecting device; and
(b2) performing a parameter change step to change the settings and parameter of the backup connection device with reference to those from the main connecting device so that the settings and parameters of the backup connection device being different from those of the main connecting device.

4. The method for backing-up a wireless area network as claim in claim 2, wherein when the first converting step calling the system parameter modification procedure; the system parameter modification procedure comprises the steps of:
(c1) performing a synchronous backup step to stop to record the settings and parameters in the main connecting device;
(c2) performing a parameter change step to change the settings and parameter of the backup connection device with reference to those from the main connecting device so that the settings and parameters of the backup connection device being different from those of the main connecting device; and
(c3) changing the backup connection device into a temporary main connecting device to perform works of the main connecting device.

5. The method for backing-up a wireless area network as claim in claim 2, wherein when the second converting step calling the system parameter modification procedure, the system parameter modification procedure comprises the steps of:
(d1) performing a synchronous backup step to stop to record the settings and parameters in the main connecting device;
(d2) performing a parameter change step to change the settings and parameter of the backup connection device with reference to those from the main connecting device so that the settings and parameters of the backup connection device being different from those of the main connecting device; and
(d3) changing the backup connection device into a temporary main connecting device to perform works of the main connecting device.

6. The method for backing-up a wireless area network of claim 1, wherein when the first converting step calls the system sleep and awake procedure; the system sleep and awake procedure comprises the steps of:
(e1) awaking the backup connection device as a standby device;
(e2) transferring an authentication data with a sleep signal to the main connecting device; and
(e3) causing the main connecting device to sleep.

7. The method for backing-up a wireless area network as claim in claim 2, wherein when the first converting step calls the system alert procedure, the system alert procedure further comprises the steps of: informing faults of the main connecting device in the complex mode to the system manager.

8. The method for backing-up a wireless area network as claim in claim 2, wherein when the second converting step calls the system alert procedure, the system alert procedure further comprises the steps of:
informing faults of a wireless end of the main connecting device in the simple mode step to the system manager.

9. The method for backup a wireless area network as claim in claim 2, wherein when the second converting step calls the system alert procedure, the system alert procedure further comprises the steps of:
informing faults of a wired end of the main connecting device in the simple mode step to the system manager.

10. The method for backup a wireless area network as claim in claim 1, wherein the settings of the main connecting device include the user data and connection data connecting to the main connecting device.

11. The method for backup a wireless area network as claim in claim 2, wherein the parameters inputted from the system manager includes a sector of a network, a domain name, a host name, an IP address, a subnet, a channel, a wireless domain, user data, and connection data.
